(19) United States
(12) Patent Application Publication
(10) Pub. No.: US 2017/0080550 A1
(43) Pub. Date: Mar. 23, 2017

(54) ONE-WAY RATCHET TOOL SET

(71) Applicant: Chia-Yu CHEN, Taichung City (TW)

(72) Inventor: Chia-Yu CHEN, Taichung City (TW)

(21) Appl. No.: 14/857,163

(22) Filed: Sep. 17, 2015

(51) Int. Cl. B25B 13/46; B25B 13/48

(52) U.S. Cl. CPC B25B 13/461; B25B 13/481

(57) ABSTRACT

A one-way ratchet tool set includes an operating member, a clockwise connector unit and a reverse connector unit. The clockwise connector unit and the reverse connector unit are respectively provided with a plurality of clockwise ratchets and reverse ratchets that are able to be engaged mutually. By so designing, a user can have the driving portion of the operating member connected with either the clockwise connector unit or the reverse connector unit for carrying out clockwise rotation or reverse rotation according to need. The one-way ratchet tool set of this invention can attain an effect of clockwise rotation by the mutual engagement of the clockwise ratchets, or attain an effect of reverse rotation via the mutual engagement of the reverse ratchets, thus enhancing operation efficiency of a hand tool and elevating convenience in use of the hand tool.

### BACKGROUND OF THE INVENTION

1. Field of the Invention

This invention relates to a tool set, particularly to one with one-way ratchet connectors.

2. Description of the Prior Art

Conventionally, a hand tool is generally fitted with a sleeve for use, such as a screwdriver commonly seen on the market. The conventional screwdriver is formed with a handle having its front end axially connected with a shaft lever, and the sleeve is fitted at the free end of the shaft lever for installing different screwdriver heads to correspond with different screw heads so that a user can conveniently operate the screwdriver. When the user is to tighten or loosen a screw, it is necessary to have a corresponding screwdriver head assembled with the sleeve and then have the front end of the screwdriver head engaged with the slot of the screw head and thus, the user can turn the screwdriver clockwise or counterclockwise for tightening or loosening a screw. A T-shaped spanner frequently seen on the market can also be fitted with the sleeve for use.

Although foresaid conventional screwdriver and T-shaped spanner can be mounted with a sleeve for replacing different screwdriver heads so as to match with different screw heads for facilitating tightening and loosening of a screw. However, when a screw located in a long and narrow space is to be tightened or loosened, the shaft lever of a screwdriver or the connecting rod of the T-shaped spanner is necessary to be moved into the long and narrow space and operated, and after the screwdriver or the T-shaped spanner is turned for a circle at an angle that is inconvenient for a user to rotate the screw continuously, the user must first release his hands from the handle of the screwdriver and the rotating handle of the T-shaped spanner and then hold them again to keep on turning for tightening or loosening the screw. Therefore, the conventional hand tools like screwdriver and T-shaped spanner are inconvenient in operation and poor in efficiency. In view of this drawback, the inventor of this invention thinks that such conventional hand tools have to be ameliorated and hence devises this invention.

### SUMMARY OF THE INVENTION

The objective of this invention is to offer a one-way ratchet tool set, able to enhance operation efficiency of a hand tool and elevate convenience in use of the hand tool.

The one-way ratchet tool set in the present invention includes an operating member, a clockwise connector unit and a reverse connector unit combined together. The operating member is formed with a shaft barrel with an accommodating groove, which has a driving member received therein. The driving member has one end formed with a first connecting member to be connected with the driving portion of the operating member and another end annularly provided with a plurality of clockwise ratchets. Further, the clockwise connector unit is provided with a ratchet-actuated member positioned beneath the driving member and annularly provided with a plurality of second clockwise ratchets at one end corresponding to the first clockwise ratchets of the driving member, letting the first clockwise ratchets and the second clockwise ratchets engaged mutually, and the ratchet-actuated member has another end formed with a second connecting member. Furthermore, the clockwise connector unit has an elastic piece received in the accommodating groove and positioned between the shaft barrel and the driving member. The reverse connector unit is formed with a shaft barrel with an accommodating groove having a driving member received therein. The driving member has one end formed with a first connecting member to be connected with the driving portion of the operating member and another end annularly formed with a plurality of first reverse ratchets. The reverse connector unit is further provided with a ratchet-actuated member positioned under the driving member and annularly provided with a plurality of second reverse ratchets at one end corresponding to the first reverse ratchets to let the first reverse ratchets and the second reverse ratchets engaged together, and the ratchet-actuated member has another end disposed with a second connecting member. In addition, the reverse connector unit contains an elastic piece received in the accommodating groove and located between the shaft barrel and the driving member.

The one-way ratchet tool set of this invention can have the driving portion of the operating member connected with the clockwise connector unit or with the reverse connector unit for carrying out clockwise rotation or reverse rotation in accordance with a user's need. The one-way ratchet tool set of this invention can attain an effect of clockwise rotation by mutual engagement of the clockwise ratchets, or attain an effect of reverse rotation via mutual engagement of the reverse ratchets, and in the process of clockwise rotation or reverse rotation, a user's hands are needless to be removed from the operating member and can keep on holding the operating member for carrying out operation incessantly, thus elevating operation efficiency of a hand tool and enhancing convenience of the hand tool

### BRIEF DESCRIPTION OF DRAWINGS

This invention will be better understood by referring to the accompanying drawings, wherein:

FIG. 1 is perspective views of one-way ratchet tool sets in the present invention;

FIG. 2 is an exploded perspective view of an operating member and a clockwise connector unit in the present invention;

FIG. 3 is an exploded perspective view of the operating member and a reverse connector unit in the present invention;

FIG. 4 is a partial cross-sectional view of the clockwise connector unit in the present invention;

FIG. 5 is a partial cross-sectional view of the reverse connector unit in the present invention;

FIG. 6 is a schematic view of the one-way ratchet tool set in use in the present invention, illustrating that the ratchets are rotated clockwise; and

FIG. 7 is a schematic view of the one-way ratchet tool set in use in the present invention, illustrating that the ratchets are rotated counterclockwise.

### DETAILED DESCRIPTION OF THE PREFERRED EMBODIMENT

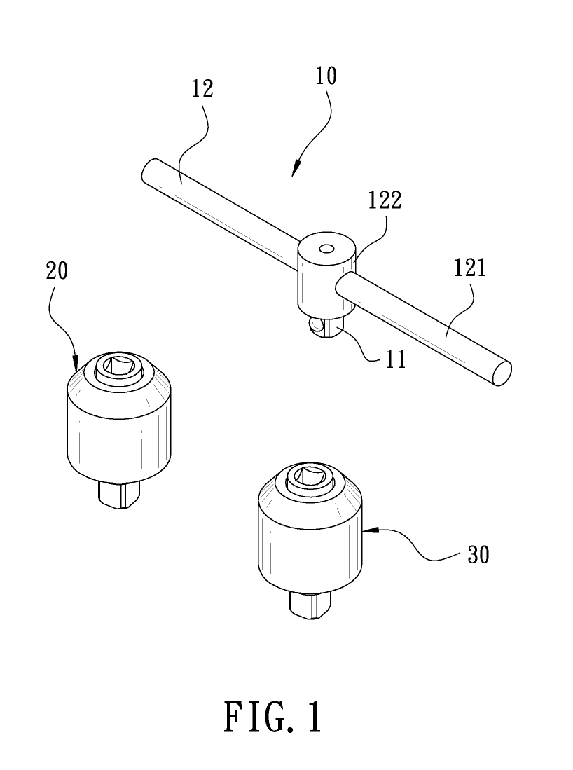

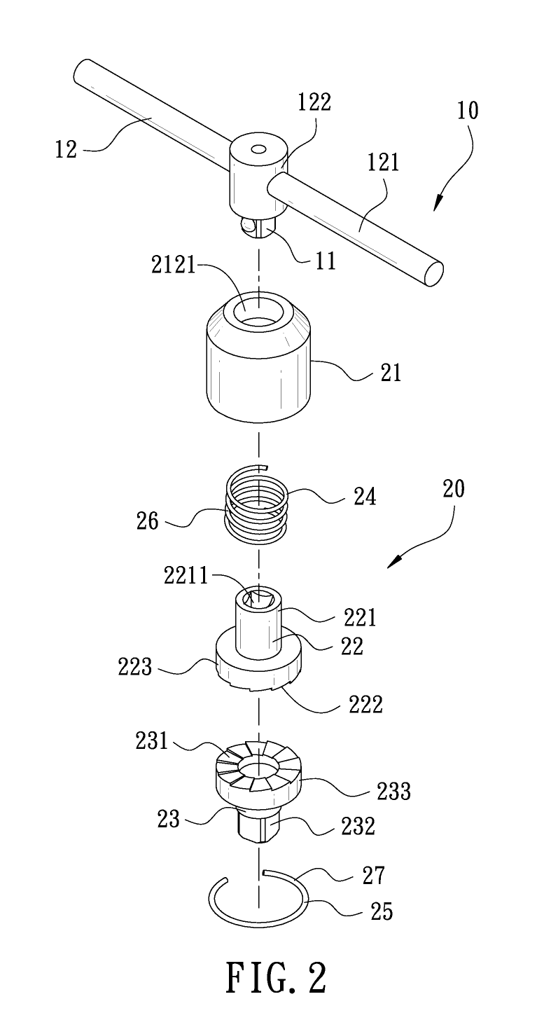

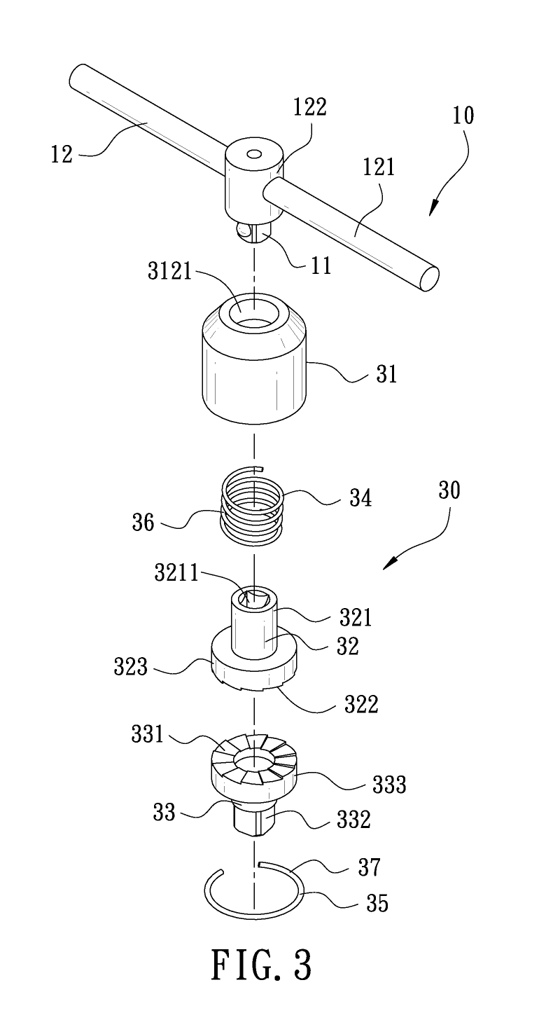

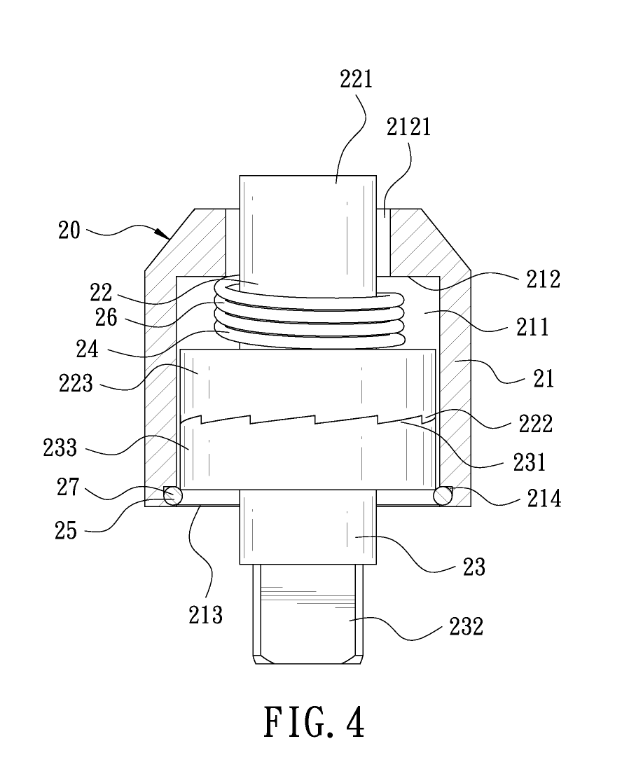

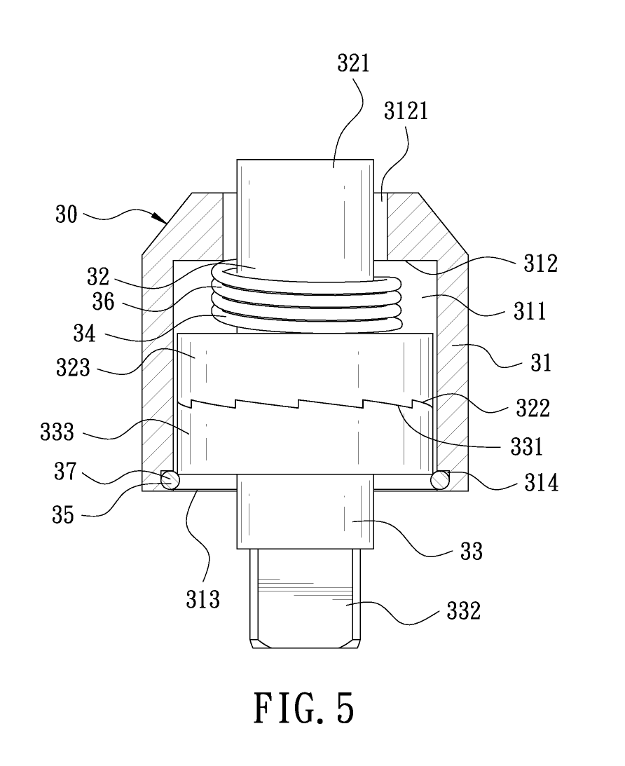

A preferred embodiment of a one-way ratchet tool set in the present invention, as shown in FIGS. 1-5, includes an operating member 10, a clockwise connector unit 20 and a reverse connector unit 30 as main components combined together.

The operating member 10 is formed with a driving portion 11 and in this invention, the operating member 10 is a sliding spanner 12 provided with a transverse rotating handle 121, which has an intermediate section fitted thereon with a vertical insert-connect rod 122 able to slide on the rotating handle 121 and having its lower end axially fixed with the driving portion 11.

The clockwise connector unit 20 is formed with a shaft barrel 21 with an accommodating groove 211, and a driving member 22 is received in the accommodating groove 211 and has one end provided with a first connecting member 221 to be connected with the driving portion 11 of the operating member 10 and another end annularly provided with a plurality of first clockwise ratchets 222. The clockwise connector unit 20 further contains a ratchet-actuated member 23 positioned beneath the driving member 22 and annularly provided with a plurality of second clockwise ratchets 231 at one end corresponding to the first clockwise ratchets 222 of the driving member 20, letting the first clockwise ratchets 222 and the second clockwise ratchets 231 engaged mutually. The ratchet-actuated member 23 has another end formed with a second connecting member 232. Furthermore, the clockwise connector unit 20 has an elastic piece 24 received in the accommodating groove 211 and located between the shaft barrel 21 and the driving member 22. In this invention, the shaft barrel 21 has one end provided with a stop portion 212 for resisting one end of the elastic piece 24, and the stop portion 212 is bored with an insert hole 2121 for the first connecting member 221 to be inserted therethrough. The shaft barrel 21 has another end formed with an opening 213 provided with an annular recess 214 for receiving a position-limiting piece 25 therein for restrictedly positioning the ratchet-actuated member 23 in the shaft barrel 21. The driving member 22 is radially provided with a protruding resisting block 223 at one end facing the opening 213. The resisting block 223 is annularly provided with the first clockwise ratchets 222 at one side facing the opening 213 and another side resisting another end of the elastic piece 24. In addition, the first connecting member 221 is provided with a recessed fitting hole 2211 for the driving portion 11 of the operating member 10 to be fitted therein, and the ratchet-actuated member 23 is radially formed with a protruding edge 233 at one end facing the opening 213, and the protruding edge 233 is annularly provided with the second clockwise ratchets 231 at one side corresponding to the first clockwise ratchets 222. The elastic piece 24 is a spring 26, and the position-limiting piece 25 is a C-shaped ring 27.

The reverse connector unit 30 includes a shaft barrel 31 formed with an accommodating groove 311, and a driving member 32 is received in the accommodating groove 311, having one end provided with a first connecting member 321 to be connected with the driving portion 11 of the operating member 10 and another end annularly provided with a plurality of first reverse ratchets 322. The reverse connector unit 30 further contains a ratchet-actuated member 33 positioned under the driving member 32 and annularly provided with a plurality of second reverse ratchets 331 at one end corresponding to the first reverse ratchets 322, letting the first reverse ratchets 322 and the second reverse ratchets 331 engaged with each other, and the ratchet-actuated member 33 has another end formed with a second connecting member 332. Further, the reverse connector unit 30 has an elastic piece 34 received in the accommodating groove 311 and positioned between the shaft barrel 31 and the driving member 32. In this invention, the shaft barrel 31 has one end formed with a stop portion 312 for pushing against one end of the elastic piece 34, and the stop position 312 is bored with an insert hole 3121 for the first connecting member 321 to be inserted therethrough. Furthermore, the shaft barrel 31 has another end formed with an opening 313 provided with an annular recess 314 for receiving a position-limiting piece 35 therein for restrictedly positioning the ratchet-actuated member 33 in the shaft barrel 31, and the driving member 32 is radially provided with a protruding resisting block 323 at one end facing the opening 313. The resisting block 323 has one side that faces the opening 313 annularly provided with the first reverse ratchets 322 and another side resisting another end of the elastic piece 34. In addition, the first connecting member 321 is disposed with a recessed fitting hole 3211 for the driving portion 11 of the operating member 10 to be fitted therein, and the ratchet-actuated member 33 is radially provided with a protruding edge 333 at one end facing the opening 313 and the protruding edge 333 is annularly provided with the second reverse ratchets 331 at one side corresponding to the first reverse ratchets 332. The elastic piece 34 is a spring 36 and the position-limiting piece 35 is a C-shaped ring 37.

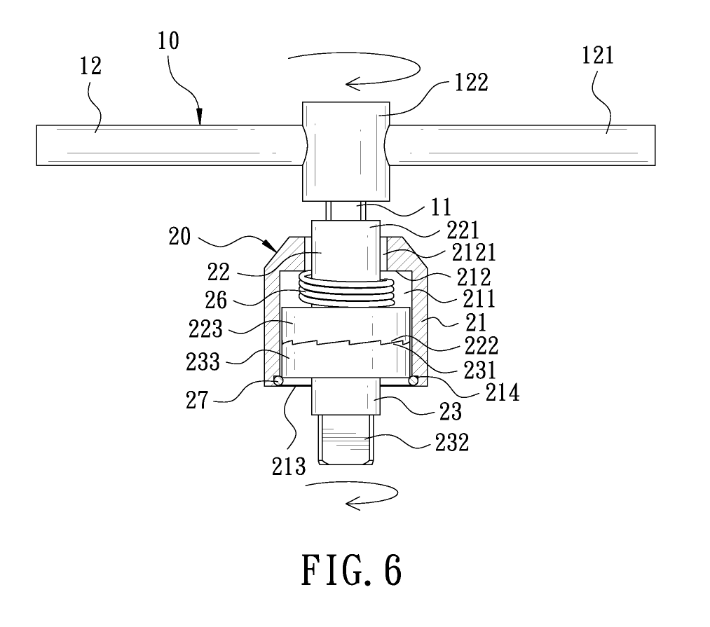

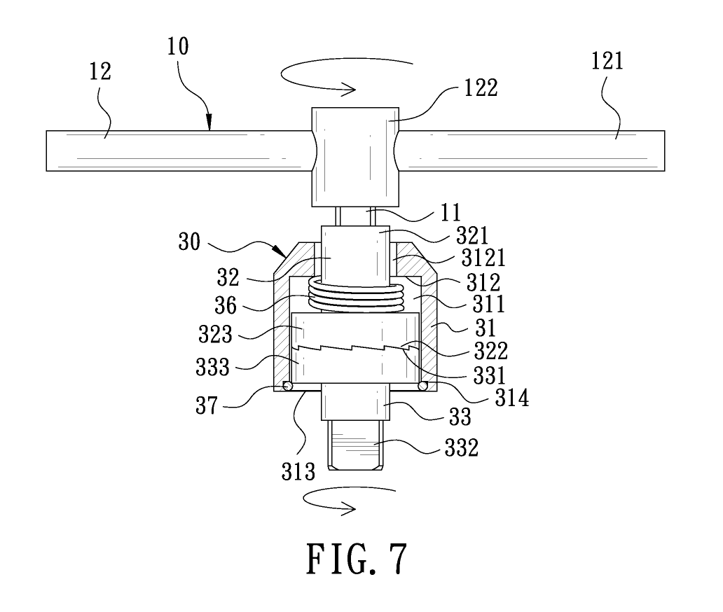

Referring to FIGS. 6 and 7 as well as FIGS. 1-5, when a user is to tighten a screw, the fitting hole 2211 of the diving member 22 of the clockwise connector unit 20 is first fitted with the driving portion 11 of the sliding spanner 12, and the screwdriver head is correspondingly installed with the second connecting member 232 of the clockwise connector unit 20. Next, the rotating handle 121 is rotated clockwise to have the first clockwise ratchets 222 of the driving member 22 actuating the second clockwise ratchets 231 of the ratchet-actuated member 23 to rotate clockwise and simultaneously, the screwdriver head fitted with the second connecting member 232 will be driven to rotate clockwise for locking tight the screw. When the rotating handle 121 is turned clockwise to an angle that is inconvenient for the user to keep on turning the rotating handle 121, the rotating handle 121 can be rotated counterclockwise and at this time, the bevel edges of the first clockwise ratchets 222 will slip off the bevel edges of the second clockwise ratchets 231 to make the driving member 22 run idle and impossible to drive the ratchet-actuated member 23 to rotate any longer. And, the first clockwise ratchets 222 and the second clockwise ratchets 231 can be kept in an engaged state via the spring 26; therefore, when the rotating handle 121 is turned counterclockwise to reach a location that is convenient for the user to operate, the user can once more turn around the rotating handle 121 clockwise for continuously tightening the screw. Thus, in a process of turning and tightening a screw, a user's hands can keep on holding the rotating handle 121 to carry out operation, needless to be released from the rotating handle 121 and then hold the rotating handle 121 anew. When a user is to loosen a screw, the fitting hole 3211 of the reverse connector unit 30 is first fitted with the driving portion 11 of the sliding spanner 12, and a screwdriver head corresponding with the screw is combined with the second connecting member 332 of the reverse connector unit 30 and then, the rotating handle 121 is turned counterclockwise to have the first reverse ratchets 322 of the driving member 32 actuating the second reverse ratchets 331 of the ratchet-actuated member 33 to rotate counterclockwise and simultaneously, the screwdriver head fitted with the second connecting member 332 will be rotated reversely for loosening the screw. When the rotating handle 121 is turned counterclockwise to an angle that is inconvenient for the user to turn the rotating handle 121, the rotating handle 121 can be turned clockwise and at this time, the bevel edges of the first reverse ratchets 322 will slip off the bevel edges of the second reverse ratchets 331 to make the driving member 32 run idle and impossible to drive the ratchet-actuated member to rotate. Moreover, the first reverse ratchets 322 and the second reverse ratchets 331 can be kept in an engaged state by means of the spring 36; therefore, when the rotating handle 121 is turned clockwise to reach a position that is convenient for the user to carry out operation, the user can once again turn the rotating handle 121 counterclockwise for continuously loosening the screw. Thus, in the course of loosening a screw, it is unnecessary for a user to remove his hands from the rotating handle 121 and then hold the rotating handle afresh. By so designing, a user can have the driving portion 11 of the operating member 10 connected with the clockwise connector unit 20 or with the reverse connector unit 30 to attain an effect of clockwise rotation via the first clockwise ratchets 222 and the second clockwise ratchets 231 that are engaged mutually, or attain an effect of reverse rotation via the mutual engagement of the first reverse ratchets 322 and the second reverse ratchets 331. And, in the process of clockwise rotation or reverse rotation of the rotating handle 121, a user's hands are unnecessary to be released from the operating member 10, thus elevating operation efficiency and convenience of hand tools.

While the preferred embodiment of the invention has been described above, it will be recognized and understood that various modifications may be made therein and the appended claims are intended to cover all such modifications that may fall within the spirit and scope of the invention.

What is claimed is:

1. A one-way ratchet tool set comprising:
an operating member, said operating member provided with a driving portion;
a clockwise connector unit, said clockwise connector unit formed with a shaft barrel, said shaft barrel provided with an accommodating groove, a driving member received in said accommodating groove, said driving member having one end formed with a first connecting member, said first connecting member connected with said driving portion of said operating member, said driving member having another end annularly provided with a plurality of first clockwise ratchets, said clockwise connector unit further provided with a ratchet-actuated member, said ratchet-actuated member positioned beneath said driving member, said ratchet-actuated member annularly provided with a plurality of second clockwise ratchets at one end corresponding to said first clockwise ratchets, said first clockwise ratchets and said second clockwise ratchets engaged mutually, said ratchet-actuated member having another end formed with a second connecting member, said clockwise connector unit further containing an elastic piece, said elastic piece received in said accommodating groove and positioned between said shaft barrel and said driving member; and
a reverse connector unit, said reverse connector unit formed with a shaft barrel, said shaft barrel provided with an accommodating groove, said accommodating groove received therein with a driving member, said driving member having one end formed with a first connecting member, said first connecting member connected with said driving portion of said operating member, said driving member having another end annularly provided with a plurality of first reverse ratchets, said reverse connector unit further consisting of a ratchet-actuated member positioned under said driving member, said ratchet-actuated member annularly disposed with a plurality of second reverse ratchets at one end corresponding to said first reverse ratchets of said driving member, said first reverse ratchets and said second reverse ratchets engaged with each other, said ratchet-actuated member having another end formed with a second connecting member, said reverse connector unit further having an elastic piece, said elastic piece received in said accommodating groove and positioned between said shaft barrel and said driving member;
Said driving portion of said operating member able to be connected with said clockwise connector unit or with said reverse connector unit for use in accordance with a user's need, said one-way ratchet tool set able to attain an effect of clockwise rotation by mutual engagement of said first clockwise ratchets and said second clockwise ratchets, or attain an effect of reverse rotation via mutual engagement of said first reverse ratchets and said second reverse ratchets.

2. The one-way ratchet tool set as claimed in claim 1, wherein said shaft barrels respectively have one end provided with a stop portion for resisting one end of said elastic piece, each said stop portion bored with an insert hole for said first connecting member to be inserted therethrough, said shaft barrel having another end formed with an opening, said opening disposed with an annular recess for receiving a position-limiting piece therein to restrictedly position said ratchet-actuated member in said shaft barrel.

3. The one-way ratchet tool set as claimed in claim 2, wherein said driving members are respectively and radially provided with a protruding resisting block at one end facing said opening, said resisting block of said clockwise connector unit and said resisting block of said reverse connector unit respectively and annularly provided with said first clockwise ratchets and said first reverse ratchets, said resisting blocks respectively having another side resisting one end of said elastic piece, said first connecting members respectively bored with a fitting hole to be fitted with said driving portion of said operating member.

4. The one-way ratchet tool set as claimed in claim 2, wherein said ratchet-actuated members are respectively and radially provided with a protruding edge at one end facing said opening, said protruding edges respectively and annularly formed with said second clockwise ratchets and second reverse ratchets at one side corresponding to said first clockwise ratchets and said first reverse ratchets.

5. The one-way ratchet tool set as claimed in claim 1, wherein said elastic piece is a spring.

6. The one-way ratchet tool set as claimed in claim 1, wherein said position-limiting piece is a C-shaped ring.

7. The one-way ratchet tool set as claimed in claim 1, wherein said operating member is a sliding spanner.
